(19) United States
(12) Patent Application Publication
(10) Pub. No.: US 2020/0240622 A1
(43) Pub. Date: Jul. 30, 2020

(54) HANDLE WITH LIGHT TO ATTACH TO ANY ITEM

(71) Applicants: Daniel Austin, Kailua Kona, HI (US); Brenda Austin, Kailua Kona, HI (US)

(72) Inventors: Daniel Austin, Kailua Kona, HI (US); Brenda Austin, Kailua Kona, HI (US)

(21) Appl. No.: 16/775,230

(22) Filed: Jan. 28, 2020

Related U.S. Application Data
(63) Continuation-in-part of application No. 62/797,607, filed on Jan. 28, 2019.
Application No. 62/797,607 is a continuation-in-part of application No. 62/911,118, filed on Oct. 4, 2019.

(51) Int. Cl. F21V 21/40; F21V 21/16

(52) U.S. Cl. CPC F21V 21/406; A45F 5/00; F21V 21/16

(57) ABSTRACT

An apparatus wherein upper cords surround an object such as a water bottle or yoga mat. The upper cords go through an opening in a handle and have cord locks on the ends. The lower cords of an apparatus attach to a light source on go through an opening in the handle and have a cord lock holding the handle on. The lower cords also surround an object such as a water bottle or yoga mat.

### CROSS REFERENCE TO RELATED APPLICATIONS

This application is a continuation in part of. This application claims the benefit of U.S. Provisional Application Ser. No. 62/797,607 filed by Daniel Austin on Jan. 28, 2019 and U.S. Provisional Application Ser. No. 62/911,118 filed by Daniel Austin on Oct. 4, 2019 which is incorporated herein by reference.

### FIELD OF INVENTION

The invention relates to light and handle attachments. Many items from beverages to yoga mats need a handle and a light. The present invention combines both a light and a handle in one invention.

### BACKGROUND OF THE INVENTION

Many people gather or travel at night. Some people walk on the beach or jog in the city with a need to carry a light and a drink bottle. Other times people are carrying items after dark such as their yoga mat and need a light and a way to keep their mat contained.

Consequently, a number of people choose to drink bottled water in order to ensure that the water that they drink is of good quality. Additionally, individuals may choose to drink from water bottles as they need a portable source of water such as when they are jogging, working out, and the like. Carrying a water bottle, or two, can serve not only as a spontaneous hydration source, but also as a source of additional weight against which an exercising person may work.

While certain water bottles may provide a shape or surface that is easily grasped, generally, water bottles are cylindrical in shape having a base (sometimes tapered) and a threaded neck that engages, a screw top cap. Under certain circumstances, the water bottle may be difficult to engage or require a holder of some sort that provides means by which the water bottle may be grasped, carried, or attached to a third item.

As a novelty, water bottle holders are sometimes sold that enable a person to carry a water bottle over his or her shoulder. Certain other devices may also be present in the art that enable persons to carry water bottles manually, in conjunction with backpacks, book bags or the like, or enable individuals to better handle a water bottle when exercising or working out.

U.S. Pat. Nos. 4,724,971; 4,379,578; 1,825,897; and 4,667,359 all disclose bottle carrying devices having a small upper loop which connects around the neck and a larger lower loop which connects to the base of the bottle. The Brownrigg '947 and Saunders '639 patents each disclose cylindrical container carriers having two circular bands used to fit around the primary object. The Grzych '169 and Escalante '964 patents both disclose bottle handles having an integrated closed base and an upper attachment means.

U.S. design patents Des. 357,387, Des. 440,496, Des. 350,879, and Des. 149,933 all disclose water bottle straps or handles that relate to or are associated with bottle containers. European Patent Application EP0652158 discloses a bottle holding handle having hand or other receiving openings as shown in FIG. 1, elements 29 and 30.

Handles can be attached to any number of objects besides a water bottle including a bicycle or a yoga mat. The handle does not have to be attached to the neck of a water bottle.

### SUMMARY OF THE INVENTION

The present invention is an apparatus with light source attached around an object with a handle for carrying.

### BRIEF DESCRIPTION OF DRAWINGS

FIG. 1 is a front perspective view of the apparatus.

FIG. 2 is a back perspective view of the apparatus.

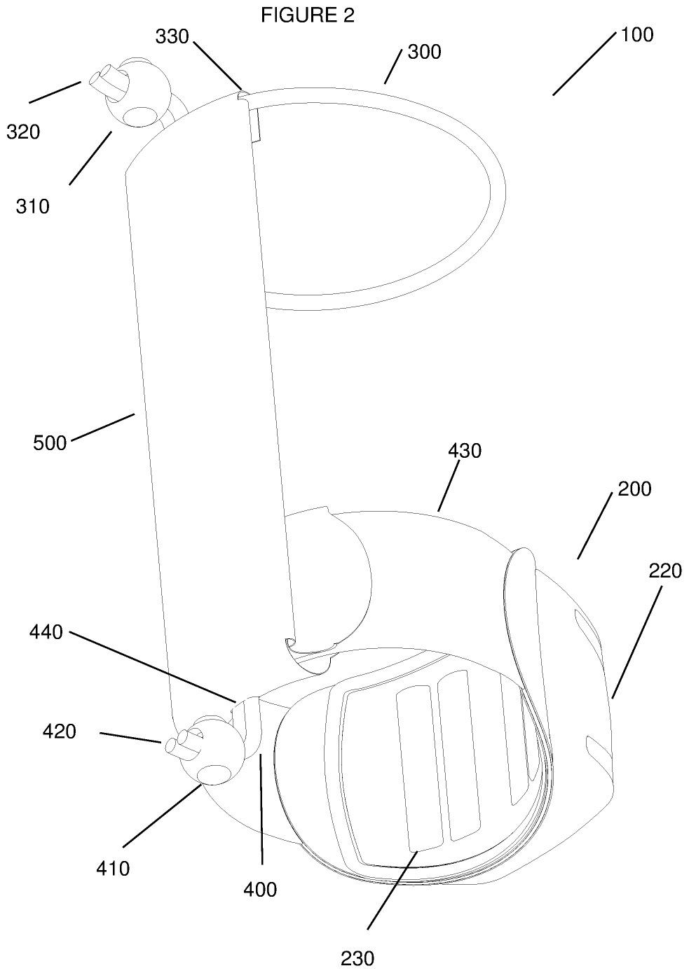

FIG. 3 is a front elevational view of the apparatus.

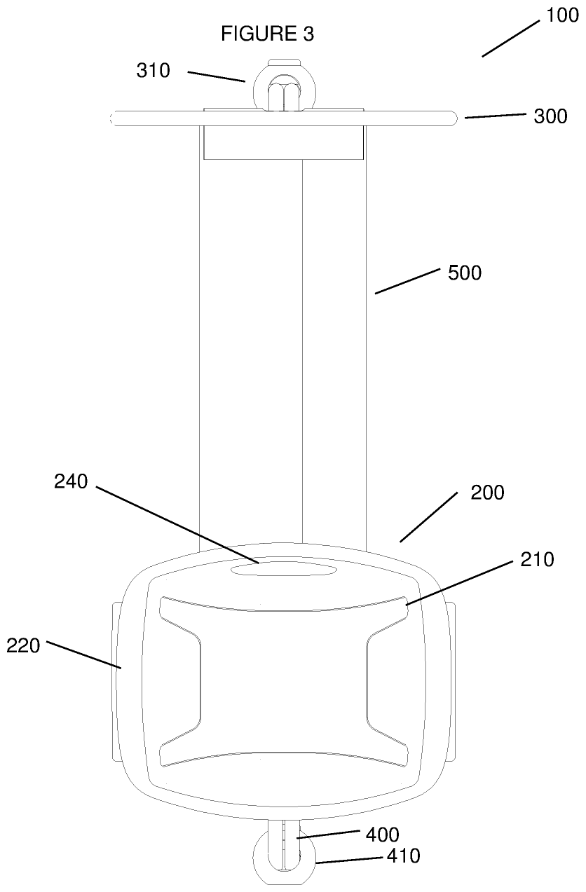

FIG. 4 is a side elevational view of the apparatus.

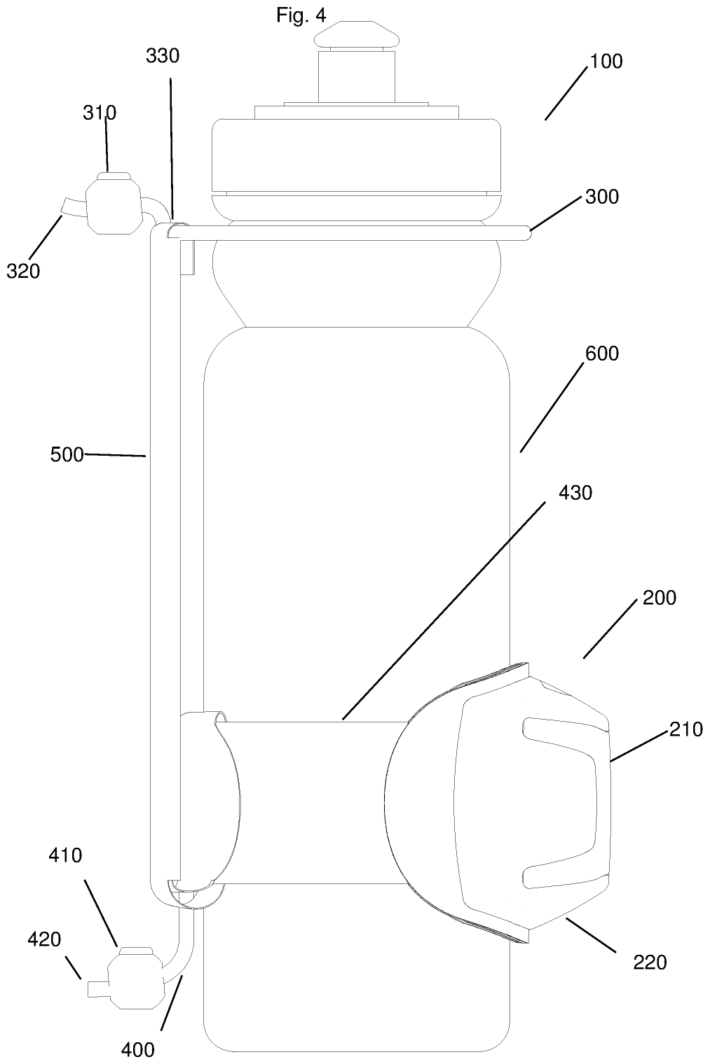

### DETAILED DESCRIPTION OF THE INVENTION

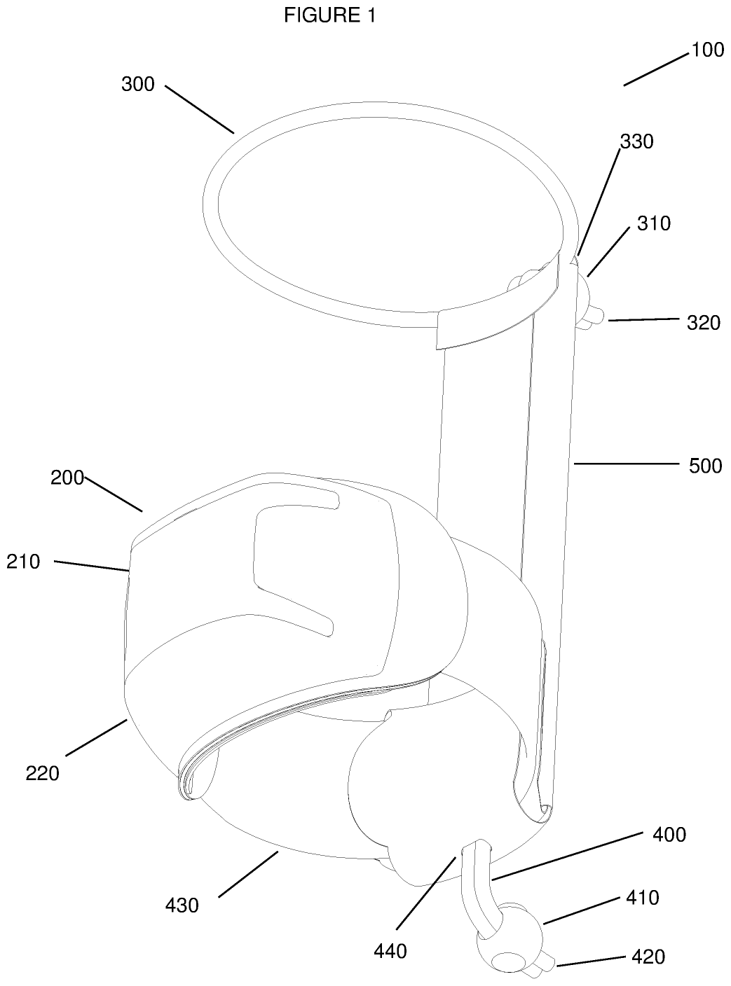

The present invention is an apparatus 100 with a light source 200 attached to a lower cord 400 or cords. See FIG. 1. The lower cord 400 is connected to a light source on the proximal end of a cord on each lateral side of the light source 200. The lower cord could have a covering 430. The distal end of the lower cords are inserted into an opening 440 in a handle 500 with a cord lock 410 holding both distal lower ends 420 of together. The cord lock 410 can be slid along the length of the cord 400 to make the handle 500 closer to the light source 200. An upper cord 300 has a cord lock 310. The upper cord 300 goes through a handle 500. The ends 320 of the cord 300 are pulled and into a cord lock 310.

The upper cord lock 310 and lower cord lock 410 holding two ends 420, 320 of a cord may be moved away from the light source 200 to make a space for an object 600. The cord locks 310, 410 may be removed so that the ends 320, 420 could be tied around an object 600 such as a bicycle. If the cords 300, 400 are not tied around the bicycle, it may be possible to put the cord lock 310, 410 back on or put some other device to hold both ends so that the cords do not slip off the bicycle. The apparatus 100 may be used on the front or back of a bicycle as a light. It could also be used with a bicycle and as a water holding device. Additionally, the handle 500 may be removed from the cord 300, 400 and used without it. Or some of the cords 300, 400 may be inserted in some other object and tied, a cord lock 310, 410 used, or another device similar to a cord lock 310, 410, which allows two ends 320, 420 to be held in place close to the light source 200.

The cords 300, 400 could be a round cordlike piece or it could be more like a strip of fabric or other material. The cords 300, 400 may be elastic or inelastic. Other materials from which the cords 300, 400 may be made include but are not limited to natural materials, for example, leather or natural fibers, polymeric materials, for example, nylon; or elastomeric materials, for example, rubber. The cords 300, 400 may include an adjustment apparatus so that it may adjusted with a slide mechanism.

The cord lock 310, 410 could be any type of clasp, cinch, or object which allows the cords 300, 410 to be fixed in place. In one embodiment, the cord lock 310, 410 may have a button when depressed loosens around the cord 300, 400 and when not depressed tightens around the cord 300, 400. The cord lock 310, 410 can have a spring inside it to exert pressure on a toggle inside a barrel, keeping the cord lock on the cord ends.

The handle 500 could be made out of sewed fabric or it could be fashioned from plastics, rubber, polymers, metal, wood, clay, ceramic, graphite, or bone. It can be made of elastic or non-elastic fabric. It can be any shape with openings 330, 440 for the cord to fit through. Each cord 300, 400 may have its own separate opening 330, 440 or two pieces of the cord could fit through one hole. The cord 300, 400 could be wrapped around one or more holes and secured by a form of tying or secured with a cord lock 310, 410.

The cord or cords 300, 400 could be placed though holes in any thing and secured so the cord cannot go back through the holes 330, 440. Thus securing the light source 200 onto the thing. The cord or cords 300, 400 can be secured together using a cord lock 310, 410 which could be fasteners including but not limited to buttons, snaps, or velcro. A cord lock 310, 410 is used here as any item which can be used to hold a cord 300, 400 in place. Each cord 300, 400 could have its own cord lock 310, 410 or both of the cords 300, 400 could be in the same cord lock 310, 410.

The light source 200 could have the cord 300, 400 threaded through its housing 220 or could be attached in some other manner to the housing 220 such as glue, fasteners, or pressure fittings. The light source 200 could be one or more bulbs under a clear plastic part 210 inserted into a housing 220. The housing 200 having a battery door 230 and an on/off switch 240.

The cord 300, 400 can be enclosed in fabric, plastic, elastic, or other part. The cord 300, 400 can be attached to another cord, another piece of fabric, elastic, or piece of any other material including but not limited to plastic, metal, rubber, or wood instead of direct to the handle 500 or light source housing 220. The cord 300, 400 does not have to be attached directly to the light source 200.

The apparatus 100 may or may not include a handle 500, pockets, clips, or any other type of attachment device. The apparatus 100 may or may not: include a light source 200 that may or may not be rechargeable or solar-powered. The apparatus 100 can include WIFI compatibility, a global positioning system, automatic sensors to operate functions, emergency distress capabilities, water resistance, charging station for other devices, USB port, Bluetooth capabilities, GPS tracking, additional device holder, interchangeable advertising/logo, emergency call feature, multiple incandescent or LED lights or colored lights, and clips/carabiner.

The apparatus 100 may or may not be attached to any item moveable or non-moveable object. The apparatus 100 may or may not have a light source that is adjustable or non-adjustable on any type of material rigid/non-rigid with or without a handle and projects light in a standard or non-standard method or pattern.

The apparatus 100 can be used for any purpose including but not limited to outdoor sports, camping, hiking, security/safety and as a promotional/commercial item.

We claim:

1. An apparatus comprising a light source with a first set of cords wherein a cord is attached on either side of the light source wherein the cords pass through a proximal end of a handle and end in an adjustable cord lock and another cord has both a first and second end passing through a distal end of a handle, wherein an adjustable cord lock attaches the ends together.

2. The first set of cords in claim 1 where in the first set of cords is enclosed within a piece fabric along all or part of the length of the cord between the light source and handle.

3. The handle in claim 1 made of cloth.

4. The apparatus in claim 1 wherein the cords encircle a water bottle.
